(19) United States
(12) Patent Application Publication
(10) Pub. No.: US 2004/0082248 A1
(43) Pub. Date: Apr. 29, 2004

(54) Cleaning and dusting fabric

(75) Inventors: Rebecca D. Harman, Oak Creek, WI (US); Randal S. Klimowicz, Caledonia, WI (US); Rene M. Beland, Waterford, WI (US)

Correspondence Address: S.C. JOHNSON & SON, INC., 1525 HOWE STREET, RACINE, WI, 53403-2236, US

(73) Assignee: S.C. Johnson & Son, Inc., Racine, WI

(21) Appl. No.: 10/655,515

(22) Filed: Sep. 5, 2003

Related U.S. Application Data
(60) Provisional application No. 60/408,229, filed on Sep. 6, 2002.

(51) Int. Cl. D04H 5/02

(52) U.S. Cl. 442/402

(57) ABSTRACT

A first layer (3) includes about 50 to about 100 percent rayon by dry weight, the first layer (3) having dust collection properties as well as liquid absorbency. A second layer (5) includes a polymer spunbond that provides a structural base for the cleaning and dusting fabric that is soft yet resists tearing. The first layer (3) and the second layer (5) are hydroentangled. A third layer (7) includes thermoplastic fibers having a melting temperature lower than that of each of the first and the second layers (3, 5) and the third layer (7) is hydroentangled to at least one of the first layer (3) and the second layer (5).

This application claims benefit of copending U.S. Provisional Patent Application No. 60/408,229, entitled Cleaning and Dusting Fabric, which was filed on Sep. 6, 2002.

### FIELD OF THE INVENTION

This invention relates to a fabric for dusting and cleaning. In particular, the fabric of the invention may be used to pick up dust when the fabric is dry, and is absorbent so that the fabric can be used with a liquid solvent or polish or to clean up liquid spills.

### BACKGROUND OF THE INVENTION

Homes are dusty. Dust may come from any number of sources, such as shoe soles carrying dust from the yard or people and pets inhabiting the home. The air itself may hold dust produced by such disparate sources as factories and far-off volcanoes, and this dust may be carried by the air and brought into the home through open windows or HVAC systems. Having entered the home, the dust settles and leaves an unsightly and unsanitary film, if left unattended, on everything in the home.

Homes are also dirty. Dirt may come from beverages spilled on countertops, coffee tables or floors. The dirt may also come from pets and people tracking in dirt from outside the home, infants, dropped food such as potato chips, and any number of other sources.

To keep one's home clean in spite of the dust and dirt, the home must be almost constantly patrolled, dusted and cleaned. Producers realize the battle consumers face in keeping their homes clean, and have developed various fabrics that can be placed on mop heads, or shaped into mitts, to make dusting and cleaning as convenient a task as possible. These fabrics are in many instances disposable, so that a consumer can use the fabric, then dispose of the fabric.

There remains a need in the art for a fabric that is soft to the touch and picks up dust when dry, but is also absorbent so that the fabric can be used with a solvent or polish, or to clean up liquid spills.

### SUMMARY OF THE INVENTION

According to one aspect of the invention, a cleaning and dusting fabric comprises a first layer that includes about 50 to about 100 percent rayon by dry weight, the first layer having dust collection properties as well as liquid absorbency. A second layer includes a polymer spunbond that provides a structural base for the cleaning and dusting fabric that is soft yet resists tearing. The first layer and the second layer are hydroentangled. A third layer includes thermoplastic fibers having a melting temperature lower than that of each of the first and the second layers and the third layer is hydroentangled to at least one of the first layer and the second layer.

In another aspect of the invention, a cleaning and dusting mitt comprises a first layer comprising about 50 to about 100 percent rayon by weight and about 0 to about 25 percent polyester by weight, a second layer comprising a polypropylene spunbond, the second layer being hydroentangled to at least the first layer, and a third layer comprising fibers having a polyester core with a polyethylene sheath and a melting temperature lower than the first and the second layers, the third layer being hydroentangled to at least one of the first layer and the second layer. The first, second and third layers form a panel, the panel having a mitt shape such that corresponding panels can be superposed and a noncircumambient, heat-sealed seam formed along the edge of the panels to create an opening which permits entry of a human hand. The heat-sealed seam is formed by melting the third layer.

In yet another aspect of the invention, a method of manufacturing a cleaning and dusting fabric comprises the steps of providing a first layer comprising about 50 to about 100 percent rayon, providing a second layer comprising a polymer spunbond, providing a third layer comprising thermoplastic fibers having a melting temperature lower than that of each of the first and the second layers, feeding the first, second and third layers to a hydroentangling unit such that, as the first, second and third layers are fed, the first layer is disposed adjacent to one side of the second layer and the third layer is disposed adjacent to an opposite side of the second layer, and hydroentangling the first and third layers to at least the second layer to form the cleaning and dusting fabric.

In yet another aspect of the invention, the method of manufacturing a cleaning and dusting fabric comprises folding the cleaning and dusting fabric on itself, forming a noncircumambient heat seal along the edge of the cleaning and dusting fabric in the shape of a mitt, and cutting the cleaning and dusting fabric in the shape of a mitt such that an opening is formed along the non-heat-sealed edge that permits entry of a human hand.

In another aspect of the invention, a cleaning and dusting fabric, adapted for dry dusting or absorbing liquids, comprises a first layer comprising about 50 to about 100 percent rayon by dry weight, the first layer having dust collection properties as well as liquid absorbency, and a second layer comprising a polymer spunbond. The second layer provides a structural base for the cleaning and dusting fabric that is soft yet resists tearing. The first layer and said second layer are hydroentangled, wherein the second layer comprises polymer fibers having a melting temperature lower than that of the first layer.

### BRIEF DESCRIPTION OF THE DRAWINGS

FIG. 1 shows a schematic cross-sectional view of an embodiment of the fabric according to the present invention;

FIG. 2 shows an enlarged view of a segment of fiber according to an aspect of the present invention;

FIG. 3 shows a schematic cross-sectional view of an embodiment of the fabric according to the present invention;

FIG. 4 shows an apparatus for manufacturing the fabric of the present invention;

FIG. 5 shows a top view of an end use of the fabric according to the present invention; and

FIG. 6 shows a schematic cross-sectional view of an embodiment of the fabric according to the present invention.

### DETAILED DESCRIPTION OF THE PREFERRED EMBODIMENTS

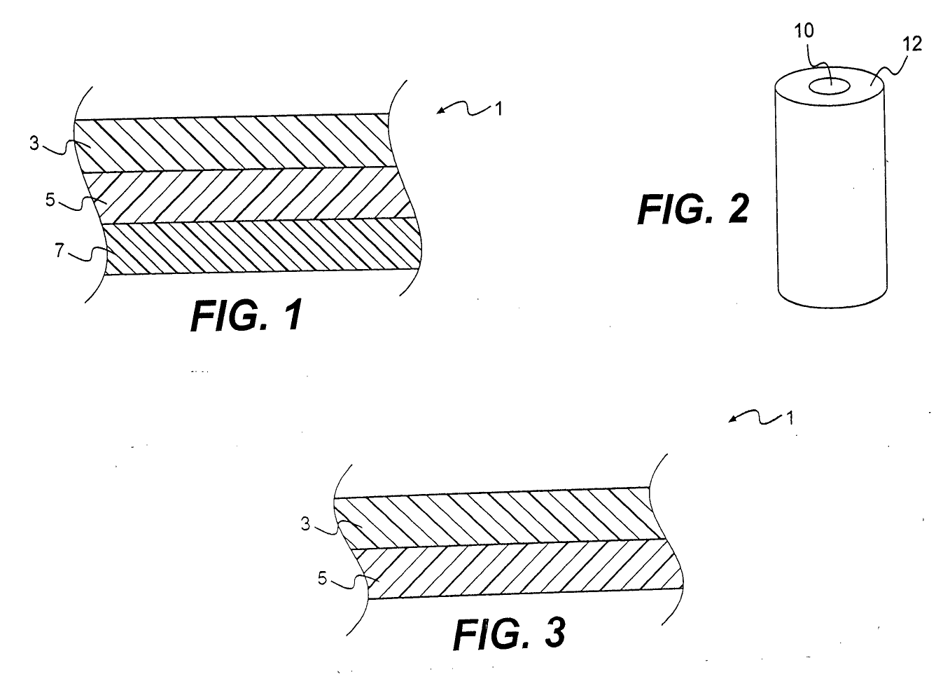

FIG. 1 shows a three-layered fabric 1 that has excellent dust collection properties, and which is also absorbent. The fabric as shown in FIG. 1 has the purpose of providing consumers a cleaning tool that both collects dust without any solvent or polish, and can also be used with liquid solvents or polishes or to clean up liquid spills. In addition, the fabric 1 is soft to the touch. Therefore, if the fabric 1 is formed into a mitt or other device designed to contact the skin, the fabric 1 will feel comfortable.

As shown in FIG. 1, the first layer 3 comprises a blend of rayon fibers, which lend absorbency to the fabric 1, and polyester fibers. The rayon fiber content of the first layer 3 may be anywhere from about 50 to about 100 percent, about 60 to 100 percent, about 75 to about 100 percent or about 80 to about 100 percent. (All references to the rayon fiber content are measured by dry weight.) Preferably, the rayon fiber content is about 100 percent. The rayon and the polyester fibers may be in the range of about 0.9 to about 1.5 deniers. Preferably, however, the rayon fiber is about 1.5 deniers, while the polyester fiber is about 0.9 deniers. (If the first layer is about 100 percent rayon, the rayon is nevertheless preferably about 1.5 denier.) Of course, other deniers may be used for either material, but it has been determined that about 1.5 denier rayon fibers provide excellent dust collection.

The basis weight of the first layer 3 is preferably about 30 g/m², but can be varied. Generally, the basis weight of the first layer 3 can be varied independently of the other layers in the fabric 1. However, varying the basis weight of the first layer 3 varies the basis weight of the fabric 1, because the basis weight of the fabric 1 is calculated by adding the basis weights of the three layers. Furthermore, the basis weight of the fabric 1 is about 40 to about 100 g/m², preferably about 50 to about 80 g/m², and most preferably about 65 g/m². Accordingly, the basis weight of the first layer 3 is preferably varied no more than is appropriate to maintain the basis weight of the fabric 1 within the above values.

The second layer 5 comprises a polymer spunbond, preferably a polypropylene spunbond. (A spunbond is a solid fiber fabric manufactured from a single strand, which is extruded onto a screen so that the fiber has a random orientation. The result is a solid, nonwoven fabric.) The second layer 5 provides structural stability and strength to the fabric 1, so that the fabric 1 will not pull apart or get snagged and rip when the fabric 1 is wiped across a surface. In addition, the second layer 5 is soft, without sharp or protruding edges. The benefit of having a polymer spunbond layer in a fabric is that, if the fabric 1 contacts a user's skin, the fabric 1 feels soft and comfortable. Other types of spunbond besides a polypropylene spunbond may be used, in which other resins, such as polyethylene, polyester, polyolefin or polyamide resins, may be substituted. A rayon spunbond may also be used.

This second layer 5 preferably has a basis weight of about 15 g/m², but the basis weight of the second layer 5 can be varied. As stated previously, however, the basis weight of the second layer 5 is preferably varied no more than is appropriate to maintain the basis weight of the fabric 1 as a whole within appropriate values.

The third layer 7 is preferably a bi-component layer comprising fibers having a polyester core 10 enveloped by a polyethylene sheath 12, as shown in FIG. 2. The basis weight of the third layer 7 is preferably 20 g/m², which may be varied as previously discussed with respect to the first and second layers. Alternatively, instead of the polyethylene sheath 12, the third layer could be constructed with the polyester core 10 enveloped by a co-polyester sheath.

Preferably, the third layer 7 has a low melting temperature, relative to the other layers in the fabric 1. This low melting temperature facilitates heat sealing the fabric to itself or other material, which may be required in some finished products. For example, as discussed in more detail below, to produce a mitt for cleaning and dusting that conveniently fits over a user's hand, the fabric 1 is folded on itself and heat sealed in the shape of a mitt. The heat-sealing operation melts the third layers 7, which oppose each other because the fabric 1 has been folded upon itself. As a result of the melting, the opposed third layers 7 bond. Thus, a low-melting-temperature third layer 7 makes the heat sealing step possible. Once the folded fabric 1 is heat sealed, it is cut with a mitt-shaped die.

The fabric 1 comprising the above-described three layers preferably has a breaking strength of at least 500 g/30 mm, and more preferably at least 1000 g/30 mm.

An alternative embodiment to the fabric 1 described above is shown in FIG. 3. In FIG. 3, the third layer 7 is eliminated. To achieve elimination of the third layer 7, it is preferable to form the second layer 5 of a spunbond material that has a low melting temperature. Such low-melting temperature spunbonds include polyethylene and any low-melting temperature resin that can be formed into a spunbond. As previously mentioned, the low melting temperature allows the fabric I to be heat sealed to itself or other materials.

Yet another preferred embodiment of the fabric 1 is shown in FIG. 6. The fabric 1 of this embodiment is substantially the same as that of FIG. 1, except that the third layer is identical to the first layer 3. That is, this embodiment comprises a pair of first layers 3, with a second layer 5 interposed therebetween. Each of the first layers 3 comprises a blend of rayon fibers, which lend absorbency to the fabric 1, and polyester fibers having the same construction described with respect to FIG. 1. The second, middle layer 5 comprises a polymer spunbond, preferably a polypropylene spunbond, and is constructed in the same manner described with respect to FIG. 1. In all other respects the fabric 1 depicted in FIG. 6 is identical to that of FIG. 1.

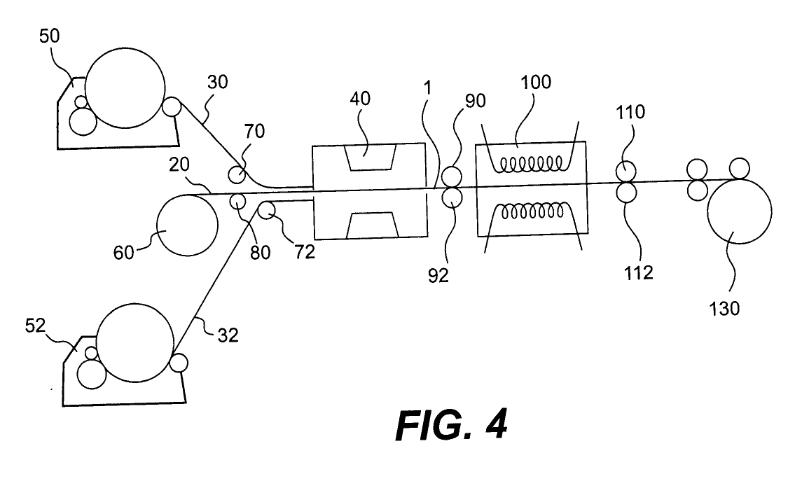

A preferred method of manufacturing the fabric 1 depicted in FIG. 1 will now be discussed. FIG. 4 is a schematic view showing an example of an apparatus for producing the fabric 1.

With the apparatus shown in FIG. 4, a rayon/polyester fiber mat 30 and a bi-component fiber mat 32 are continuously delivered from carding machines 50, 52, via delivery rolls 70, 72. A feed roll 60 for a polypropylene spunbond 20 is located between the carding machines 50, 52. The polypropylene spunbond 20 is delivered from the feed roll 60 via a delivery roll 80.

The fiber mats 30, 32 are superposed upon the opposite sides of the polypropylene spunbond 20 at the point of the delivery rolls 70, 72, and the combination of the fiber mats 30, 32 and the polypropylene spunbond 20 is conveyed into a hydroentangling unit 40. In the hydroentangling unit 40, the fibers of the fiber mats 30, 32 are entangled with the polypropylene spunbond 20 by the action of a water jet. Also, the fiber mats 30, 32, which are located on opposite surfaces of the polypropylene spunbond 20, are entangled with each other. In this manner, a fabric I is prepared.

After the entanglement, the fabric 1 could be passed between nip rolls 90, 92, if a coating is desired to be placed on the fabric. Regardless, the fabric 1 is conveyed into a heating unit 100. In the heating unit 100, the fabric 1 is subjected to heat treatment for drying. The heat treatment does not subject the fabric 1 to a temperature sufficient to melt any of the layers. The fabric 1, after being subjected to the heat treatment, is passed between nip rolls 110, 112 and is wound into a finish roll 130. In this manner, the fabric 1, which has the structure shown in FIG. 1, is obtained.

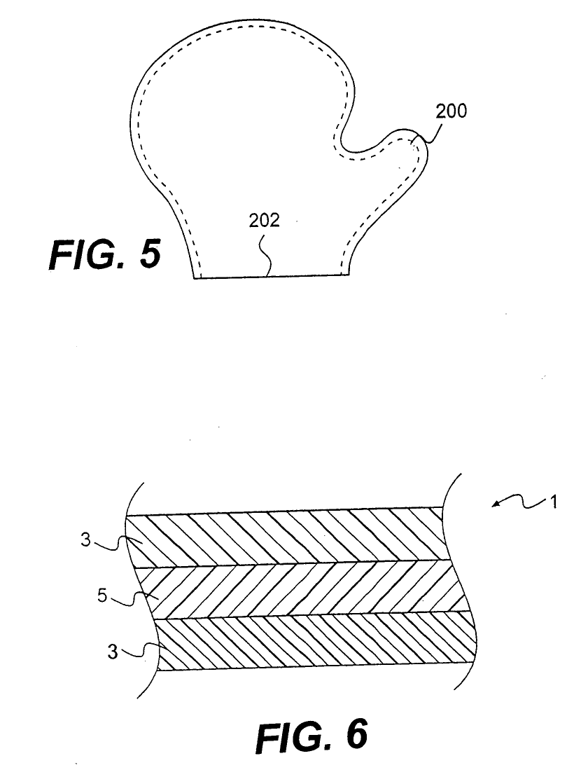

Once the fabric 1 is obtained, the fabric 1 may undergo additional processing for different products. For example, to create a mitt as shown in FIG. 5, the fabric 1 may be unwound from the finish roll 130, folded, heat sealed to itself along seam 200, and cut in the shape of a mitt with a mitt-shaped die. Naturally, the seam 200 is mitt-shaped and is noncircumambient so that it does not seal the bottom of the mitt. The unsealed portion creates an opening 202. The opening 202 permits a user to insert the user's hand.

Other shapes, sizes and uses are also contemplated for the fabric 1. For example, the fabric 1 may be cut into rectangular sections. The rectangular sections, called a cloth, may be placed by a consumer on the end of a mop or sweeper for the purpose of dusting and cleaning floors.

Many different embodiments of the present invention may be constructed without departing from the spirit and scope of the present invention. It should be understood that the present invention is not limited to the specific embodiments described in this specification. To the contrary, the present invention is intended to cover various modifications and equivalent arrangements included within the spirit and scope of the invention as hereafter claimed. The scope of the following claims is to be accorded the broadest interpretation so as to encompass all such modifications, equivalent structures and functions.

Industrial Applicability

The fabric as claimed herein has the purpose of providing consumers a cleaning tool that both collects dust without any solvent or polish, and can also be used with liquid solvents or polishes or to clean up liquid spills. In addition, a method is claimed for manufacturing such a fabric.

We claim:

1. A cleaning and dusting fabric, adapted for dry dusting or absorbing liquids, comprising:
a first layer comprising about 50 to about 100 percent rayon by dry weight, said first layer having dust collection properties as well as liquid absorbency; and
a second layer comprising a polymer spunbond, said second layer providing a structural base for said cleaning and dusting fabric that is soft yet resists tearing, said first layer and said second layer being hydroentangled; and
a third layer comprising thermoplastic fibers having a melting temperature lower than that of each of said first and said second layers, said third layer being hydroentangled to at least one of said first layer and said second layer.

2. A cleaning and dusting fabric according to claim 1, wherein said polymer spunbond is polypropylene spunbond.

3. A cleaning and dusting fabric according to claim 1, wherein said first layer comprises about 75 to about 100 percent rayon by weight.

4. A cleaning and dusting fabric according to claim 1, wherein said first layer comprises about 80 percent rayon by weight.

5. A cleaning and dusting fabric according to claim 1, wherein said third layer comprises fibers comprising a polyester core enveloped by a polyethylene sheath.

6. A cleaning and dusting fabric according to claim 1, wherein said cleaning and dusting fabric has a basis weight within the range of about 40 g/m² to about 100 g/m².

7. A cleaning and dusting fabric according to claim 1, wherein said first and third layers are disposed on opposite sides of said second layer.

8. A cleaning and dusting fabric according to claim 1, wherein said third layer comprises at least one of polyester fibers and polyethylene fibers.

9. A cleaning and dusting fabric according to claim 1, said first layer further comprising polyester.

10. A cleaning and dusting mitt comprising:
a first layer comprising about 50 to about 100 percent rayon by weight and about 0 to about 25 percent polyester by weight;
a second layer comprising a polypropylene spunbond, said second layer being hydroentangled to at least said first layer; and
a third layer comprising fibers having a polyester core with a polyethylene sheath and a melting temperature lower than said first and said second layers, said third layer being hydroentangled to at least one of said first layer and said second layer,
said first, second and third layers forming a panel, the panel having a mitt shape such that corresponding panels can be superposed and a noncircumambient, heat-sealed seam formed along the edge of the panels to create an opening which permits entry of a human hand, wherein the heat-sealed seam is formed by melting said third layer.

11. A method of manufacturing a cleaning and dusting fabric comprising the steps of:
providing a first layer comprising about 50 to about 100 percent rayon;
providing a second layer comprising a polymer spunbond;
providing a third layer comprising thermoplastic fibers having a melting temperature lower than that of each of the first and the second layers;
feeding the first, second and third layers to a hydroentangling unit such that, as the first, second and third layers are fed, the first layer is disposed adjacent to one side of the second layer and the third layer is disposed adjacent to an opposite side of the second layer; and
hydroentangling the first and third layers to at least the second layer to form the cleaning and dusting fabric.

12. A method of manufacturing according to claim 11, further comprising drying the cleaning and dusting fabric after said step of hydroentangling.

13. A method of manufacturing according to claim 12, further comprising:
folding the cleaning and dusting fabric on itself;
forming a noncircumambient heat seal along the edge of the cleaning and dusting fabric in the shape of a mitt; and
cutting the cleaning and dusting fabric in the shape of a mitt such that an opening is formed along the non-heat-sealed edge that permits entry of a human hand.

14. A cleaning and dusting fabric, adapted for dry dusting or absorbing liquids, comprising:
a first layer comprising about 50 to about 100 percent rayon by dry weight, said first layer having dust collection properties as well as liquid absorbency; and
a second layer comprising a polymer spunbond, said second layer providing a structural base for said cleaning and dusting fabric that is soft yet resists tearing, said first layer and said second layer being hydroentangled, wherein said second layer comprises polymer fibers having a melting temperature lower than that of said first layer.

15. A cleaning and dusting fabric according to claim 14, wherein said polymer spunbond is polyethylene spunbond.

16. A cleaning and dusting fabric according to claim 14, wherein said first layer comprises about 80 percent rayon by weight.

17. A cleaning and dusting fabric according to claim 14, wherein said cleaning and dusting fabric has a basis weight within the range of about 40 g/m² to about 100 g/m².

18. A cleaning and dusting fabric according to claim 14, said first layer further comprising polyester.

19. A cleaning and dusting fabric according to claim 14, said first and second layers forming a panel, the panel having a mitt shape such that corresponding panels can be superposed and a noncircumambient, heat-sealed seam formed along the edge of the panel to create an opening which permits entry of a human hand, wherein the heat-sealed seam is formed by melting said second layer.
